(19) United States
(12) Patent Application Publication
(10) Pub. No.: US 2007/0071419 A1
(43) Pub. Date: Mar. 29, 2007

(54) Reproducing device provided with resume function

(75) Inventors: Yuji Umeda, Echizen-city (JP); Chika Fujii, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/508,154

(22) Filed: Aug. 23, 2006

(30) Foreign Application Priority Data
Sep. 26, 2005 (JP) 2005-277454

(51) Int. Cl. H04N 7/26; G11B 20/10

(52) U.S. Cl. 386/124; 369/47.11

(57) ABSTRACT

A reproducing device provided with a resume function capable of storing a plurality of stop positions through a simple operation is provided. In a reproducing device 1 for reproducing a recording medium 2, if an operation of stop position storage means 12c of a microcontroller 12 is instructed by operation means 14 during reproduction of video, the stop position storage means 12c erases the oldest stop position from among stop positions stored in a stop position storage area 13a which is capable of storing a plurality of stop positions of a memory 13 which stores stop position information on positions at which the video is stopped and stores the stop position in a free space area of the stop position storage area 13a resulting from such an erasure, and can thereby store a plurality of stop positions through a simple operation.

The present application is based on and claims priority of Japanese patent application No. 2005-277454 filed on Sep. 26, 2005, the entire contents of which are hereby incorporated by reference.

### BACKGROUND OF THE INVENTION

1. Field of the Invention

The present invention relates to a reproducing device provided with a resume function capable of storing a stop position and invoking the stop position through a simple operation and storing a plurality of stop positions.

2. Description of the Related Art

Conventionally, various methods related to a resume function for a reproducing device which reproduces a storage medium such as a disk, capable of storing a stop position and continuing the reproduction from the stop position next time are disclosed.

Japanese Patent Laid-Open Publication No. 2005-100623 (Patent Document 1) discloses a method for enabling reproduction from a stop position by prompting each user to set a password, enter the user name and password when using a reproducing device, thereby identifying the user, storing stop position information for each user so that reproduction can be resumed from the stop position.

Furthermore, Japanese Patent Laid-Open Publication No. 2005-25883 (Patent Document 2) discloses a method for resuming reproduction from a stop position by registering user IDs beforehand, selecting a user ID identifying an individual user from a list of registered user IDs before reproduction, storing stop positions for the respective user IDs at the time of stopping and thereby resuming reproduction from the stop position at the next reproduction.

However, the methods according to Patent Documents 1 and 2 have a disadvantage of involving user registration and password registration which makes operation complicated.

### SUMMARY OF THE INVENTION

The present invention has been implemented in view of the above described problems and it is an object of the present invention to provide a reproducing device provided with a resume function which is easy to operate and capable of storing a plurality of stop positions.

The reproducing device provided with a resume function according to a first aspect of the present invention is a reproducing device comprising reproduction starting means for starting reproduction of video stored in a storage medium, reproduction stopping means for stopping the video being reproduced, stop position storage means capable of storing a predetermined number of stop positions when the video being reproduced is stopped, reproduction start position selection means for continuing reproduction of the video from a stop position selected by a user from among the plurality of stop positions stored by the stop position storage means at the next reproduction of the video, information storage means for storing the plurality of stop positions and operation means for allowing the user to perform operation using keys corresponding to the reproduction starting means and the reproduction stopping means, wherein the stop position storage means stores a history of past stop positions stored by the reproduction stopping means and the reproduction start position selection means selects a reproduction start position from the history of the stop positions.

According to the construction of the first aspect of the present invention, the stop position storage means can store a plurality of scenes when the video being reproduced is stopped as stop positions and the reproduction start position selection means allows the user to arbitrarily select the plurality of stored stop positions and resume the reproduction from that stop position.

The reproducing device provided with a resume function according to a second aspect of the present invention is the reproducing device provided with a resume function according to the first aspect of the present invention, wherein when the video being reproduced is stopped by the reproduction stopping means, the stop position storage means newly stores the stop position thereof after erasing the oldest one from the history of the stop positions.

According to the construction of the second aspect of the present invention, by erasing stop positions stored in a normally limited storage area one by one starting from the oldest one, it is possible to reliably store the latest stop position information.

The reproducing device provided with a resume function according to a third aspect of the present invention is the reproducing device provided with a resume function according to the first or second aspect of the present invention, wherein when the user selects a desired stop position from the history of the stop positions through the operation of the reproduction starting means carried out by the operation means within a predetermined time, the reproduction start position selection means starts the reproduction from the selected stop position.

According to the construction of the third aspect of the present invention, the operation means allows the user to select a desired stop position from the history of a plurality of stop positions within a predetermined time.

The reproducing device provided with a resume function according to a fourth aspect of the present invention is the reproducing device provided with a resume function according to any one of the first to third aspects of the present invention, wherein a Play key to operate the reproduction starting means of the operation means is used as a method of selecting the reproduction start position.

According to the construction of the fourth aspect of the present invention, the use of the Play key of the operation means which is used for reproduction of video to select a reproduction start position eliminates the necessity for any additional key for the operation means.

The reproducing device provided with a resume function according to a fifth aspect of the present invention is a reproducing device comprising reproduction starting means for starting reproduction of video stored in a storage medium, reproduction stopping means for stopping the video being reproduced, stop position storage means capable of storing a predetermined number of stop positions when the video being reproduced is stopped, reproduction start position selection means for continuing reproduction of the video from a stop position selected by a user from among the plurality of stop positions stored by the stop position storage means at the next reproduction of the video, information storage means for storing the plurality of stop positions and operation means for allowing the user to perform operation of the reproduction starting means and the reproduction stopping means, wherein the stop position storage means stores stop positions in association with the number of times the reproduction stop operation by the operation means is performed consecutively when the video being reproduced is stopped, and the reproduction start position selection means performs the same number of reproduction start operations as the number of times the reproduction stop operation is performed consecutively to thereby allow the user to select a desired stop position.

According to the construction of the fifth aspect of the present invention, if it is assumed, for example, that three stop positions; point 1, point 2, point 3, can be stored in the stop position storage means, it is possible to clearly specify the storage areas of stop positions according to the number of times the Stop key of the operation means is pressed consecutively when the video being reproduced is stopped, for example, storing the stop position at point 1 when the Stop key is pressed once, at point 2 when pressed two times, at point 3 when pressed three times, and so on. Furthermore, when the stop positions stored in this way are read during reproduction of video, the user can easily specify a desired stop position to resume the reproduction by, for example, pressing the Play key of the operation means once to resume reproduction from the stop position stored at point 1, two times at point 2, three times at point 3, and so on.

The reproducing device provided with a resume function according to a sixth aspect of the present invention is the reproducing device provided with a resume function according to any one of the first to fifth aspects of the present invention, wherein the reproduction start position selection means displays reproduction start position information superimposed on the video being reproduced when the user selects a stop position using the operation means.

According to the construction of the sixth aspect of the present invention, when selecting a reproduction start position, the user can browse the reproduction start position information displayed on the screen and easily select a desired reproduction start position.

### BRIEF DESCRIPTION OF THE DRAWINGS

FIG. 1 is a block diagram showing the construction of a reproducing device according to Embodiment 1 of the present invention;

FIG. 2 is a flow chart showing the operation of the reproducing device according to Embodiment 1 of the present invention;

FIG. 3 illustrates a screen of a display section according to Embodiment 1 of the present invention when the number of stop positions to be stored is set;

FIG. 4 illustrates an example of OSD display according to Embodiment 1 of the present invention when a desired stop position is selected; and

FIG. 5 is a flow chart showing the operation of a reproducing device according to Embodiment 2 of the present invention.

### DETAILED DESCRIPTION OF THE PREFERRED EMBODIMENTS

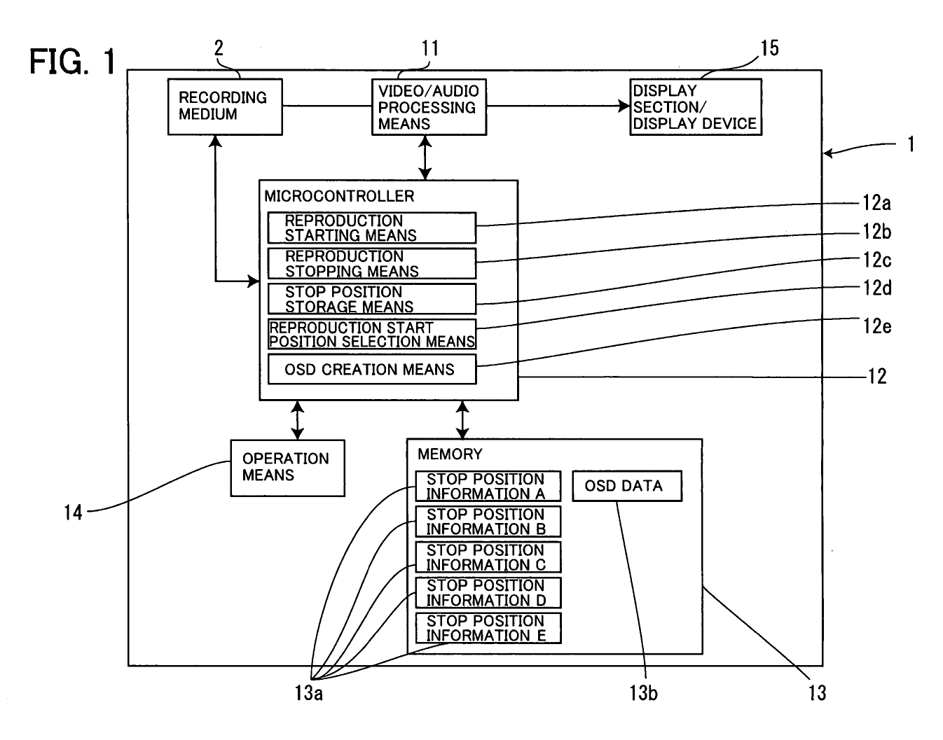

Hereinafter, as the best mode for implementing the present invention, an embodiment will be explained with reference to FIG. 1 to FIG. 4. It goes without saying that the present invention is also easily applicable to modes other than that explained in the embodiment within a range not departing from the essence of the present invention.

### Embodiment 1

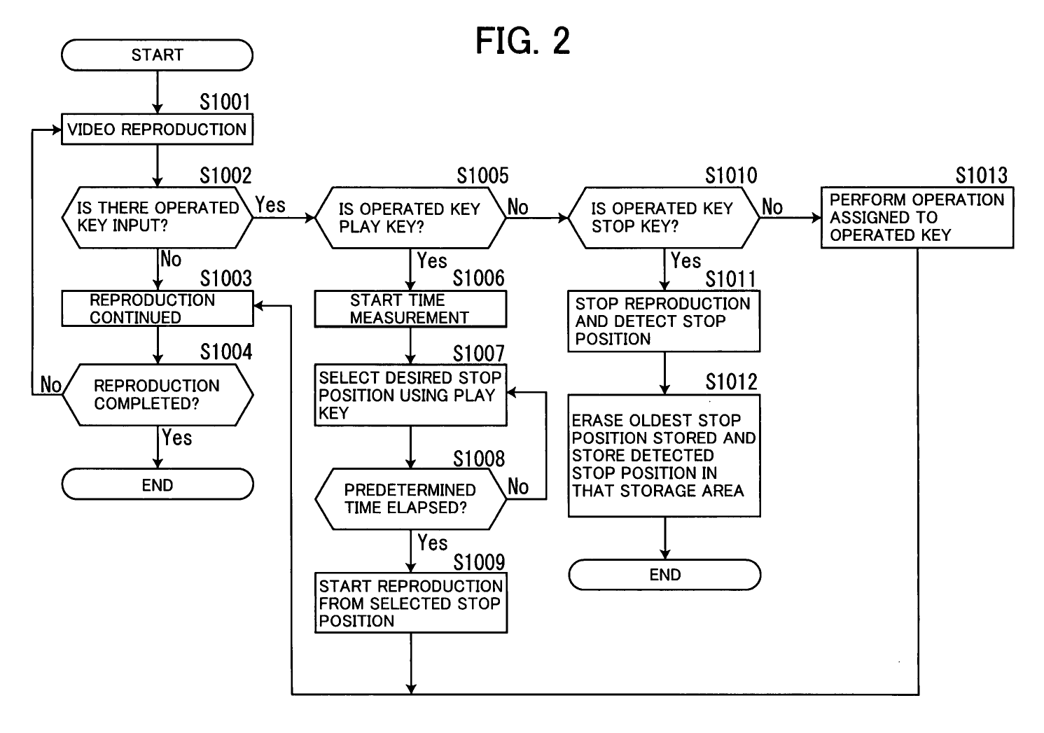

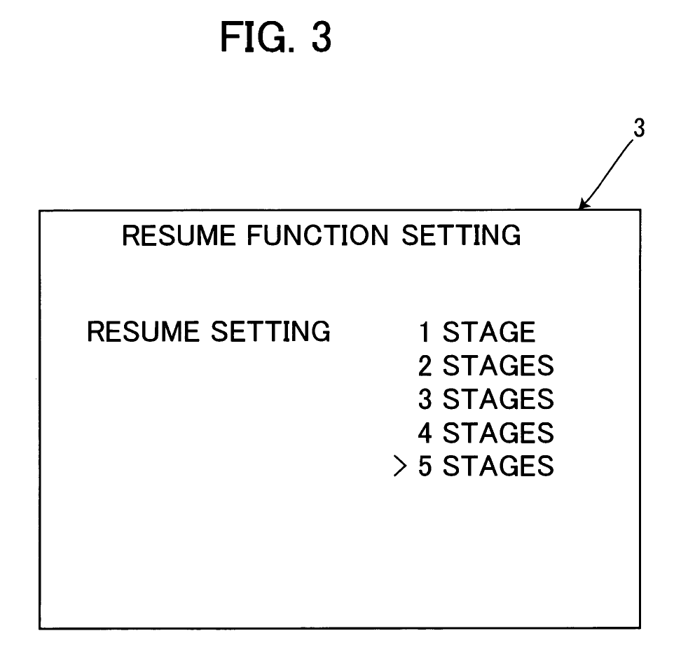

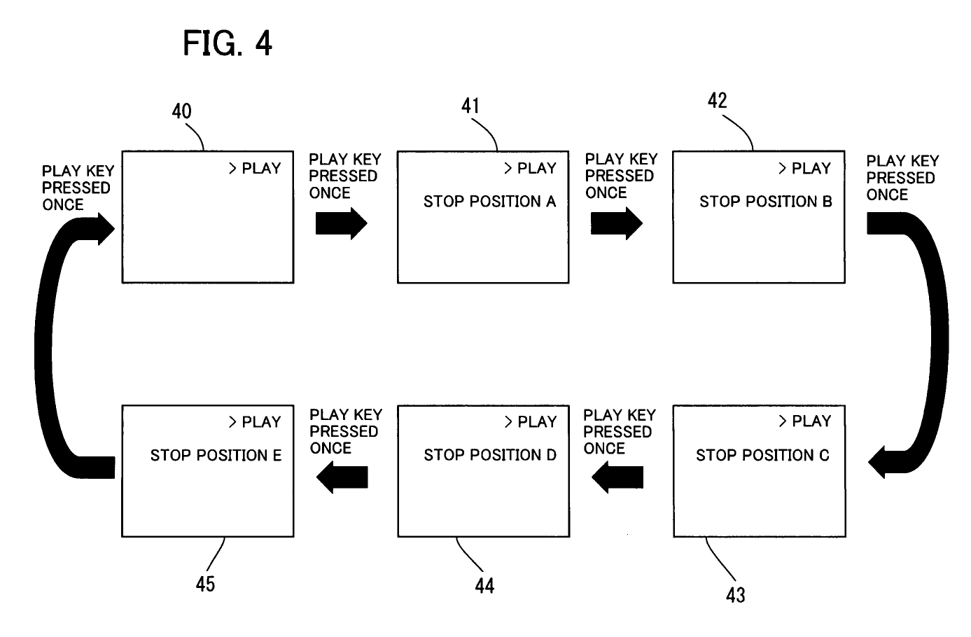

FIG. 1 to FIG. 4 show Embodiment 1 of the present invention and FIG. 1 is a block diagram showing the construction of a reproducing device according to this embodiment. FIG. 2 is a flow chart showing the operation of the reproducing device. FIG. 3 illustrates a setting screen for setting the number of stop positions to be stored of the reproducing device. FIG. 4 illustrates a method of switching between stop positions.

The structure of a reproducing device according to this embodiment will be explained based on FIG. 1. Reference numeral 1 denotes a reproducing device, which reproduces video stored in a storage medium such as an optical disk, hard disk drive or the like. Reference numeral 2 denotes the aforementioned storage medium. Reference numeral 11 denotes a video/audio processing means, which converts video/audio data stored in the storage medium 2 to a video/audio signal. Reference numeral 12 denotes a microcontroller, which controls the operation of the storage reproducing device 1. The microcontroller 12 is provided with a reproduction starting means 12a which starts reproduction of the video/audio stored in the storage medium 2, a reproduction stopping means 12b which stops the video/audio being reproduced, a stop position storage means 12c which stores the position of the video/audio stopped in a memory which will be described later, a reproduction start position selection means 12d which selects and reads the reproduction start position from stop position information which will be described later stored in the memory by the stop position storage means 12c and an OSD creation means 12e for displaying information super imposed on the video. Reference numeral 13 denotes a memory which is information storage means and which includes stop position information 13a for storing a plurality of stop positions stored by the stop position storage means 12c and OSD data 13b to be superimposed on the video as an OSD display by the OSD creation means 12d. Reference numeral 14 denotes operation means including a Play key, Stop key or the like for the user to operate the reproducing device 1. Reference numeral 15 denotes a display section or display device which displays the video/audio stored in the storage medium 2.

Next, the operation of the reproducing device will be explained based on FIG. 2. First, video is reproduced (S1001). It is judged whether or not the user has operated the operation means 14 during reproduction (S1002). When no operation is found, reproduction of the video continues (S1003), the operation is stopped when the video being reproduced ends, and when the video does not end, the process returns to step S1001 and continues the reproduction of the video (S1004). When operation by the user is found in step S1002, it is judged whether or not the operated key is the Play key (S1005). When the operated key is the Play key, time measurement is started (S1006), a desired stop position is selected through the operation of the Play key (S1007). Operation of selecting the stop position is accepted until a predetermined time passes after this (S1008), and after a lapse of a predetermined time, information on the stop position selected from a history of stop positions is acquired by the reproduction start position selection means 12d and reproduction from the stop position is resumed (S1009). After this, the process moves to step S1003 and the reproduction operation continues. When it is found in step S1005 that the operated key is not the Play key, it is judged whether or not the operated key is the Stop key (S1010). When the key is the Stop key, reproduction of the video is stopped and the stop position is detected (S1011). The oldest stop position information 13a stored in the memory 13 which is storage means is erased, the stop position information detected in the same area is stored in the memory 13 by the stop position storage means 12c (S1012). When it is found in step S1010 that the operated key is not the Stop key, the operation of the reproducing device corresponding to the operated key is performed and after the operation ends, the reproduction is continued (S1013).

Next, the method of setting the number of stop positions to be stored will be explained based on FIG. 3. Reference numeral 3 denotes a screen for setting the number of stop positions to be stored. It is possible to set 1 stage to 5 stages using a cursor and when, for example, 3 stages is set, it is possible to store three stop positions. In this way, it is possible to store stop positions corresponding to the number of users who use the reproducing device 1.

Next, the method of selecting a desired stop position from the stored stop positions will be explained based on FIG. 4. According to the aforementioned setting of the number of stop position to be stored, suppose the number of stop position to be stored is set to 5. Reference numeral 40 shows a state of the display section while the video stored in the storage medium is being reproduced. When the Play key is pressed once in this state, an OSD display indicating a state in which the stop position stored in the stop position information A13a is selected is performed as shown with reference numeral 41. When the Play key is pressed once more, an OSD display indicating a state in which the stop position information B13a is selected is performed, and an OSD display indicating a stop position being selected is performed thereafter every time the Play key is pressed. When the Play key is pressed with the stop position E selected, the selection of the stop position is finished and the process returns to normal reproduction.

When video being reproduced is stopped in the reproducing device configured as shown above, a plurality of past stop positions can be stored, and therefore even when the reproducing device 1 is used by a plurality of users, it is possible to store the respective stop positions. Furthermore, the method of storing a stop position is performed by simply pressing the Stop key, which provides excellent operability. Furthermore, even when reproduction is continued from a desired stop position, video is selected by further pressing the Play key during reproduction of the video, which eliminates the necessity for complicated operation and improves convenience.

### Embodiment 2

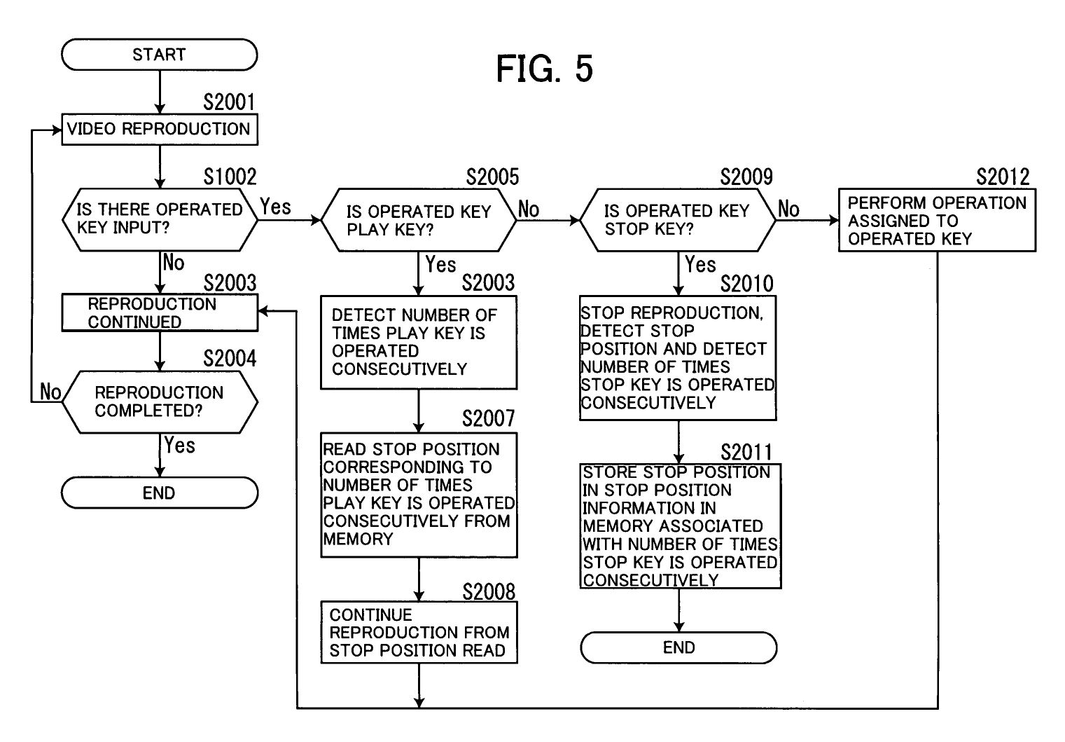

FIG. 5 is a flow chart showing Embodiment 2 of the present invention and the same parts as those in Embodiment 1 are assigned the same reference numerals and detailed explanations thereof will be omitted. First, video is reproduced (S2001). During reproduction, it is judged whether the user performs operation using operation means 14 or not (S2002). When no operation is found, reproduction of the video is continued (S2003) and when the reproduction of the video is finished, the operation is stopped and when the reproduction is not finished, the process returns to step S2001 and the reproduction of the video is continued (S2004). When operation by the user is found in step S2002, it is judged whether the operated key is the Play key or not (S2005). When the operated key is the Play key, the number of times the Play key is operated consecutively within a predetermined time is detected (S2006), the stop position is read from the stop position information 13a stored in the memory 13 using the reproduction start position selection means 12d based on the detected number of times (S2007) and the video is reproduced from the stop position read (S2008). After this, the process moves to step S2003 and the reproduction operation continues. When the operated key is not the Play key in step S2005, it is judged whether the operated key is the Stop key or not (S2009). When the operated key is the Stop key, the reproduction of the video is stopped, the stop position is detected by the stop position storage means 12c and at the same time the number of times the Stop key is operated consecutively is detected (S2010). The stop position detected in the same way is stored by the stop position storage means 12c in the stop position information 13a inside the memory associated with the detected number of times (S2011). When the operated key is not the Stop key in step S2009, the operation of the reproducing device corresponding to the operated key is performed and after the operation is completed, the reproduction is continued (S2012).

In the reproducing device configured as shown above, unlike aforementioned Embodiment 1, the method of storing the stop position becomes more complicated, but the storage area of the stop position can be specified clearly. Furthermore, the method of specifying the storage area where the stop position is stored and the method of resuming reproduction from a desired stop position are associated with the same number of times the Stop key or Play key is operated respectively, and therefore it is possible to clearly specify the storage area of a desired stop position and perform storage and invoking.

The embodiments of the present invention have been explained in detail so far, but the present invention is not limited to the foregoing embodiments and can be implemented modified in various ways within a range not departing from the essence of the present invention. For example, there will be no problem if a method of selecting a desired stop position from among a plurality of stop positions is adopted whereby stop positions are displayed in a list on an OSD display and a desired stop position is selected using operation means.

The effects of the present invention are as follows.

The reproducing device provided with a resume function according to a first aspect of the present invention is a reproducing device comprising reproduction starting means for starting reproduction of video stored in a storage medium, reproduction stopping means for stopping the video being reproduced, stop position storage means capable of storing a predetermined number of stop positions when the video being reproduced is stopped, reproduction start position selection means for continuing reproduction of the video from a stop position selected by a user from among the plurality of stop positions stored by the stop position storage means at the next reproduction of the video, information storage means for storing the plurality of stop positions and operation means for allowing the user to perform operation using keys corresponding to the reproduction starting means and the reproduction stopping means, wherein the stop position storage means stores a history of past stop positions stored by the reproduction stopping means and the reproduction start position selection means selects a reproduction start position from the history of the stop positions. Therefore it is possible to store up to a predetermined number of past stop positions from the latest one where the video being reproduced is stopped by the reproduction stopping means as a history using the stop position storage means and the user can select a desired stop position from this history of stop positions using the operation means and resume reproduction from that stop position.

According to the reproducing device provided with a resume function according to the second aspect of the present invention, when the video being reproduced is stopped by the reproduction stopping means, the stop position storage means newly stores the stop position thereof after erasing the oldest one from the history of the stop positions. Therefore it is possible to efficiently store stop positions in the stop position storage means having a limited storage area.

According to the reproducing device provided with a resume function according to the third aspect of the present invention, when the user selects a desired stop position from the history of the stop positions through the operation of the reproduction starting means carried out by the operation means within a predetermined time, the reproduction start position selection means starts the reproduction from the selected stop position. Therefore it is possible to realize a system for selecting a desired stop position from the history of stop positions at low cost without providing any dedicated operation means.

According to the reproducing device provided with a resume function according to the fourth aspect of the present invention, the Play key to operate the reproduction starting means of the operation means is used as a method of selecting the reproduction start position. Therefore it is possible to select a desired stop position from the history of stop positions by consecutively pressing the Play key which is pressed to reproduce video, which allows an intuitive operation.

The reproducing device provided with a resume function according to the fifth aspect of the present invention is a reproducing device comprising reproduction starting means for starting reproduction of video stored in a storage medium, reproduction stopping means for stopping the video being reproduced, stop position storage means capable of storing a predetermined number of stop positions when the video being reproduced is stopped, reproduction start position selection means for continuing reproduction of the video from a stop position selected by a user from among the plurality of stop positions stored by the stop position storage means at the next reproduction of the video, information storage means for storing the plurality of stop positions and operation means for allowing the user to perform operation of the reproduction starting means and the reproduction stopping means, wherein the stop position storage means stores stop positions in association with the number of times the reproduction stop operation by the operation means is performed consecutively when the video being reproduced is stopped, and the reproduction start position selection means performs the same number of reproduction start operations as the number of times the reproduction stop operation is performed consecutively. Therefore when the reproduction stopping means is operated, by storing the number of times the Stop key which is one of the operation means is pressed consecutively together with the stop positions using the stop position storage means and pressing the Play key at the reproduction of video as many times as the Stop key is pressed consecutively, the user can reliably call up a desired stop position and continue the reproduction from that stop position.

According to the reproducing device provided with a resume function according to the sixth aspect of the present invention, the reproduction start position selection means displays reproduction start position information superimposed on the video being reproduced when the user selects a stop position using the operation means. Therefore when selecting a stop position, the user can easily determine where the desired stop position is stored.

1. A reproducing device provided with a resume function comprising:
reproduction starting means for starting reproduction of video stored in a storage medium;
reproduction stopping means for stopping the video being reproduced;
stop position storage means capable of storing a predetermined number of stop positions when the video being reproduced is stopped;
reproduction start position selection means for continuing reproduction of the video from a stop position selected by a user from among the plurality of stop positions stored by the stop position storage means at the next reproduction of the video;
information storage means for storing the plurality of stop positions; and
operation means for allowing the user to perform operation using keys corresponding to the reproduction starting means and the reproduction stopping means,
wherein the stop position storage means stores a history of past stop positions stored by the reproduction stopping means and the reproduction start position selection means selects a reproduction start position from the history of the stop positions.

2. The reproducing device provided with a resume function according to claim 1, wherein when the video being reproduced is stopped by the reproduction stopping means, the stop position storage means newly stores the stop position thereof after erasing the oldest one from the history of the stop positions.

3. The reproducing device provided with a resume function according to claim 1, wherein when the user selects a desired stop position from the history of the stop positions through the operation of the reproduction starting means carried out by the operation means within a predetermined time, the reproduction start position selection means starts the reproduction from the selected stop position.

4. The reproducing device provided with a resume function according to claim 1, wherein a Play key to operate the reproduction starting means of the operation means is used as a method of selecting the reproduction start position.

5. A reproducing device provided with a resume function comprising:
reproduction starting means for starting reproduction of video stored in a storage medium;
reproduction stopping means for stopping the video being reproduced;
stop position storage means capable of storing a predetermined number of stop positions when the video being reproduced is stopped;
reproduction start position selection means for continuing reproduction of the video from a stop position selected by a user from among the plurality of stop positions stored by the stop position storage means at the next reproduction of the video;
information storage means for storing the plurality of stop positions; and
operation means for allowing the user to perform operation of the reproduction starting means and the reproduction stopping means,
wherein the stop position storage means stores stop positions in association with the number of times the reproduction stop operation by the operation means is performed consecutively when the video being reproduced is stopped, and
the reproduction start position selection means performs the same number of reproduction start operations as the number of times the reproduction stop operation is performed consecutively to thereby allow the user to select a desired stop position.

6. The reproducing device provided with a resume function according to claim 5, wherein the reproduction start position selection means displays reproduction start position information superimposed on the video being reproduced when the user selects a stop position using the operation means.

7. The reproducing device provided with a resume function according to claim 2, wherein when the user selects a desired stop position from the history of the stop positions through the operation of the reproduction starting means carried out by the operation means within a predetermined time, the reproduction start position selection means starts the reproduction from the selected stop position.

8. The reproducing device provided with a resume function according to claim 2, wherein a Play key to operate the reproduction starting means of the operation means is used as a method of selecting the reproduction start position.

9. The reproducing device provided with a resume function according to claim 3, wherein a Play key to operate the reproduction starting means of the operation means is used as a method of selecting the reproduction start position.

10. The reproducing device provided with a resume function according to claim 7, wherein a Play key to operate the reproduction starting means of the operation means is used as a method of selecting the reproduction start position.

11. The reproducing device provided with a resume function according to claim 1, wherein the reproduction start position selection means displays reproduction start position information superimposed on the video being reproduced when the user selects a stop position using the operation means.

12. The reproducing device provided with a resume function according to claim 2, wherein the reproduction start position selection means displays reproduction start position information superimposed on the video being reproduced when the user selects a stop position using the operation means.

13. The reproducing device provided with a resume function according to claim 3, wherein the reproduction start position selection means displays reproduction start position information superimposed on the video being reproduced when the user selects a stop position using the operation means.

14. The reproducing device provided with a resume function according to claim 4, wherein the reproduction start position selection means displays reproduction start position information superimposed on the video being reproduced when the user selects a stop position using the operation means.

15. The reproducing device provided with a resume function according to claim 7, wherein the reproduction start position selection means displays reproduction start position information superimposed on the video being reproduced when the user selects a stop position using the operation means.

16. The reproducing device provided with a resume function according to claim 8, wherein the reproduction start position selection means displays reproduction start position information superimposed on the video being reproduced when the user selects a stop position using the operation means.

17. The reproducing device provided with a resume function according to claim 9, wherein the reproduction start position selection means displays reproduction start position information superimposed on the video being reproduced when the user selects a stop position using the operation means.

18. The reproducing device provided with a resume function according to claim 10, wherein the reproduction start position selection means displays reproduction start position information superimposed on the video being reproduced when the user selects a stop position using the operation means.
